(19) United States
(12) Patent Application Publication
(10) Pub. No.: US 2011/0249947 A1
(43) Pub. Date: Oct. 13, 2011

(54) OPTO-ELECTRONIC TRANSCEIVER MODULE WITH CASTELLATED ELECTRICAL TURN

(75) Inventors: Tak Kui Wang, Cupertino, CA (US); Chung-yi Su, Fremont, CA (US)

(73) Assignee: Avago Technologies Fiber IP (Singapore) Pte. Ltd., SINGAPORE (SG)

(21) Appl. No.: 12/758,085

(22) Filed: Apr. 12, 2010

(51) Int. Cl. G02B 6/36

(52) U.S. Cl. 385/89; 385/88

(57) ABSTRACT

An opto-electronic communication module includes a module body and a circuit board having an edge with conductive castellations extending between opposing surfaces of the circuit board. At least one opto-electronic communication device, such as an opto-electronic light source or an opto-electronic light receiver, is mounted on a surface of the circuit board in an orientation in which its optical signal communication axis is normal to the surface of the circuit board and aligned with an optical signal communication port of the module body.

### BACKGROUND

In an optical communication system, it is generally necessary to couple an optical fiber to an opto-electronic transmitter, receiver or transceiver device and, in turn, to couple the device to an electronic system such as a switching system or processing system. These connections can be facilitated by modularizing the transceiver device. An opto-electronic transceiver module includes an opto-electronic light source, such as a laser, and an opto-electronic light receiver, such as a photodiode, and may also include various electronic circuitry associated with the laser and photodiode. For example, driver circuitry can be included for driving the laser in response to electronic signals received from the electronic system. Likewise, receiver circuitry can be included for processing the signals produced by the photodiode and providing output signals to the electronic system.

As illustrated in FIGS. 1-2, one type of opto-electronic transceiver module 10 known in the prior art includes a module body 12 connected to a flexible circuit substrate, commonly referred to as a flex circuit 14. Details of module body 12 and other elements are not shown for purposes of clarity. Similarly, additional elements that are commonly included, such as an outer module body or housing, and mechanical attachment or latching features, are not shown. Mounted on an upper surface of flex circuit 14 are an opto-electronic light source 16, an opto-electronic light receiver 18, and an integrated circuit device 20. A stiffener 22 is attached to the lower surface or back of flex circuit 14. As it is desired for this type of opto-electronic transceiver module to emit light in a direction parallel to the plane of the flex circuit, either the electrical signal, the optical signal, or both must undergo one or more turns in direction. In the illustrated opto-electronic transceiver module 10, light emitted by opto-electronic light source 16 passes through a first lens 24, is reflected at a 90-degree angle by a mirrored surface 26 in module body 12, passes through a second lens 28, and is emitted from opto-electronic transceiver module 10 through a transmit signal port 30 along a transmit signal axis 32. Similarly, light received through a receive signal port (not shown) along a receive signal axis 34 passes through a third lens (not shown), is reflected at a 90-degree angle by mirrored surface 26, passes through a fourth lens (not shown), and impinges on opto-electronic light receiver 18. Integrated circuit device 20 interfaces opto-electronic light source 16 and opto-electronic light receiver 18 with an external electronic system (not shown) through flex circuit 14 and includes signal driver and receiver circuitry. Thus, in opto-electronic transceiver module 10, mirrored surface 26 provides the requisite change or “turn” in signal path direction. Such an arrangement is sometimes referred to in the art as providing an “optical turn,” in contrast with an “electrical turn.”

Aligning the lenses, mirror, and other elements of the optical paths with the light source and light receiver in an opto-electronic transceiver module of the type described above can be difficult and time-consuming. These difficulties, as well as the number and complexity of optical elements in such transceiver modules, impact manufacturing economy. In addition, relatively long wirebonds or similar conductive paths may be needed to interconnect the electrical and opto-electronic elements in such transceiver modules, potentially leading to signal degradation.

### SUMMARY

Embodiments of the present invention relate to an opto-electronic communication module that includes a module body and a circuit board having an edge with conductive castellations extending between opposing surfaces of the circuit board. In some embodiments, the edge of the circuit board can be attached substantially perpendicularly to a portion of the surface of a circuit substrate such as a flex circuit or another circuit board, with the castellations providing conductive paths for electrical signals between the circuit substrate (e.g., flex circuit) and the circuit board. At least one opto-electronic communication device, such as an opto-electronic light source or an opto-electronic light receiver, is mounted on a surface of the circuit board in an orientation in which its optical signal communication axis is normal to the surface of the circuit board and aligned with the optical signal communication port of the module body. The optical signal communication axis is thus parallel to the plane of the circuit substrate. The opto-electronic communication device is electrically coupled to the conductive castellations, which provide an electrical turn in the signal path direction. In some embodiments, the opto-electronic communication device is indirectly coupled to the conductive castellations via one or more intermediate elements, such as an integrated circuit, while in other embodiments the opto-electronic communication device is directly coupled, i.e., connected, to the conductive castellations.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is sectional view of a portion of an opto-electronic transceiver module known in the prior art.

FIG. 2 is a top plan view of the flexible circuit substrate and elements mounted thereon of the known opto-electronic transceiver module shown in FIG. 1.

FIG. 3 is a perspective view of an opto-electronic transceiver module in accordance with an exemplary embodiment of the invention.

FIG. 4 is a front elevation view of the opto-electronic transceiver module of FIG. 3.

FIG. 5 is a sectional view taken on line 5-5 of FIG. 4

FIG. 6 is a perspective view of the rear portions of the opto-electronic transceiver module of FIGS. 3-4 and the attached module body portion.

FIG. 7 is a sectional view taken on line 7-7 of FIG. 6.

FIG. 8 is a front elevation view of the opto-electronic transceiver module of FIGS. 3-7.

FIG. 9 is a perspective view of the opto-electronic transceiver module of FIGS. 3-8, enclosed in an outer module body or housing.

FIG. 10 is a rear elevation view of an opto-electronic transceiver module in accordance with another exemplary embodiment of the invention.

FIG. 11 is a front elevation view of the opto-electronic transceiver module of FIG. 10.

FIG. 12 is a top plan view of the opto-electronic transceiver module of FIGS. 10-11.

FIG. 13 is a front elevation view of an opto-electronic transceiver module in accordance with still another exemplary embodiment of the invention.

FIG. 14 is a top plan view of the opto-electronic transceiver module of FIG. 13.

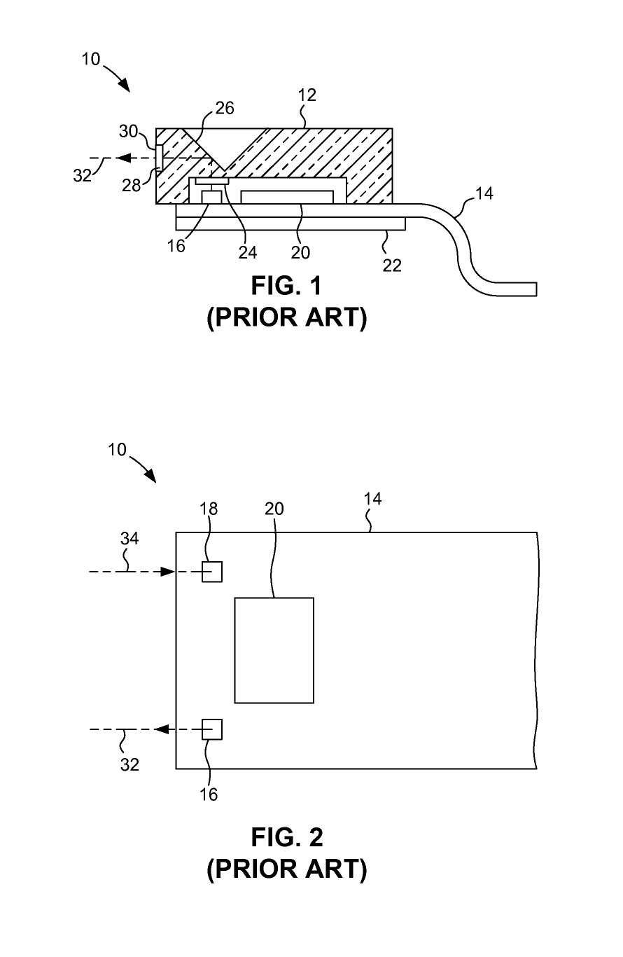

### DETAILED DESCRIPTION

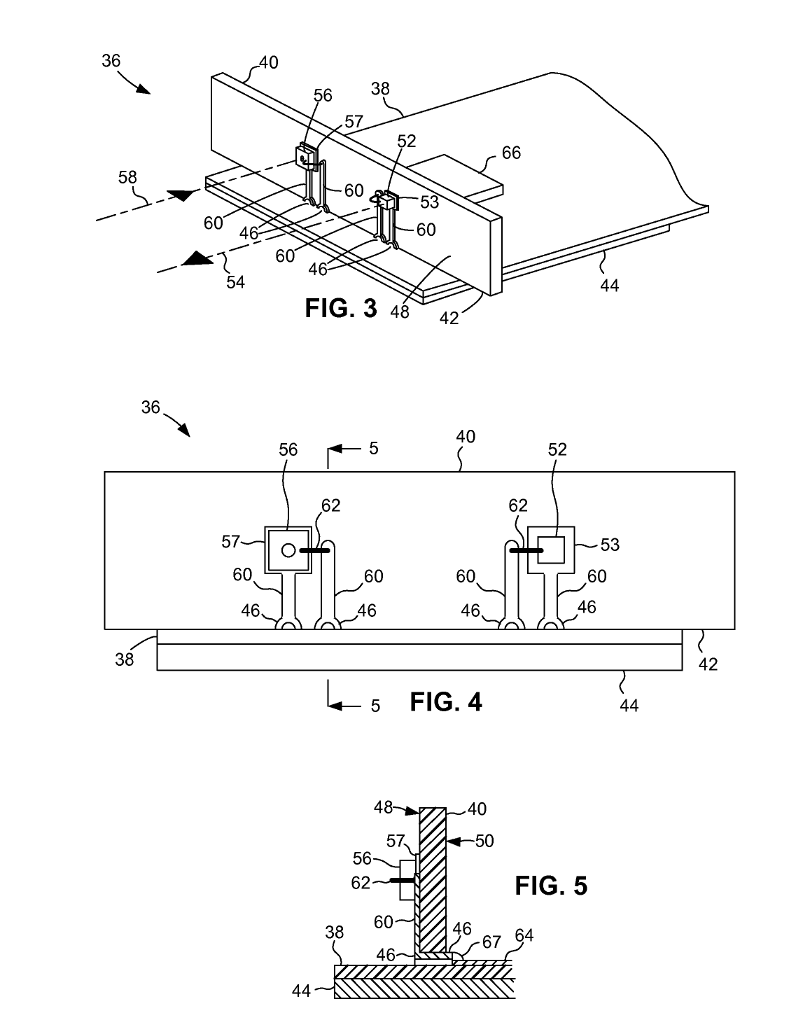

As illustrated in FIGS. 3-7, in an illustrative or exemplary embodiment of the invention, an opto-electronic transceiver module 36 includes a flexible circuit substrate or flex circuit 38 and a circuit board 40 attached substantially perpendicularly to flex circuit 38. Although in the exemplary embodiment circuit board 40 is attached to flex circuit 38, in other embodiments the circuit board can be attached to any other suitable type of circuit substrate, such as a circuit board.

As described below, a module body is also included but is not shown in FIGS. 3-5 for purposes of clarity.

In the exemplary embodiment, circuit board 40 is attached to the upper surface of flex circuit 38 along an edge 42 of circuit board 40. A generally planar stiffener 44 is attached to the lower surface of flex circuit 38 to facilitate the attachment of circuit board 40 and otherwise lend rigidity to the structure. Edge 42 includes castellations 46. (The term “castellations” or a “castellated” edge is used in the art to refer to a structure having a shape evocative of battlements atop a castle wall.) As well understood in the art, circuit board castellations comprise partial plated-through holes or vias (typically, a cylindrical via is cut in half along a diameter) in an edge of the circuit board. Castellations can be used to provide electrical signal paths between a circuit board and an adjoining circuit board or connector. As best shown in FIG. 5, castellations 46, i.e., the metal-plated interiors of halved vias, extend between the front surface 48 of circuit board 40 and the rear surface 50 of circuit board 40. Note that the drawing figures are not to scale.

An opto-electronic light source 52, such as a laser, is mounted on a pad 53 on front surface 48 of circuit board 40. When activated in response to an electrical input signal, opto-electronic light source 52 emits light along an optical signal transmit axis 54 that is substantially perpendicular or normal to front surface 48. An opto-electronic light receiver 56, such as a photodiode, is similarly mounted on a pad 57 on front surface 48 of circuit board 40. Opto-electronic light receiver 56 produces electrical signals in response to light received along an optical signal receive axis 58 impinging on opto-electronic light receiver 56. Conductive paths or circuit traces 60 electrically connect the terminals of opto-electronic light source 52 and opto-electronic light receiver 56 to corresponding ones of castellations 46. Although in the exemplary embodiment each of opto-electronic light source 52 and opto-electronic light receiver 56 has two terminals and, accordingly, is electrically connected to corresponding ones of castellations 46 by two corresponding circuit traces 60, in other embodiments there can be any suitable number of circuit traces. In the exemplary embodiment each of opto-electronic light source 52 and opto-electronic light receiver 56 is mounted on a corresponding pad at the end of a trace 60 and is electrically connected to another one of circuit traces 60 by a wirebond 62. However, in other embodiments the opto-electronic light source and opto-electronic light receiver can be connected to the circuit traces or other conductive paths in any other suitable manner.

Flex circuit 38 similarly includes conductive paths or circuit traces 64 on its upper surface that electrically connect castellations 46 to an integrated circuit device 66 mounted on the upper surface of flex circuit 38. In the exemplary embodiment, each trace 64 on the upper surface of flex circuit 38 is electrically coupled to a corresponding one of traces 60 on front surface 48 of circuit board 40 via one of castellations 46. For example, castellations 46 can be soldered 67 (FIG. 5) to circuit traces 64 on flex circuit 38. In this manner, opto-electronic light source 52 and opto-electronic light receiver 56 are electrically coupled to integrated circuit device 66 via castellations 46. Although not shown for purposes of clarity, flex circuit 38 includes additional conductive paths or traces that extend rearward along the length of flex circuit 38 and that can electrically couple integrated circuit device 66 to an external electronic system, such as a switching system or processing system (for example, a computer motherboard). Although only the front or proximal portion of flex circuit 38 is shown for purposes of clarity, a connector at the far end or distal end (not shown) of flex circuit 38 can be included to facilitate connection to such an external electronic system. In this manner, opto-electronic light source 52 and opto-electronic light receiver 56 can be electrically coupled to such an external electronic system via integrated circuit device 66, which can include suitable signal driver and signal receiver circuitry or similar circuitry of a type well known in the art. As well understood in the art, in a modular opto-electronic transceiver system such circuitry provides an electrical interface or buffer between the opto-electronics and the external electronic system. Although in the exemplary embodiment there is only one integrated circuit device 66, in other embodiments any suitable number of such devices can be included along with a correspondingly suitable number of traces and castellations for carrying associated signals. It should be understood that, as used herein, the term “coupled” means connected via zero or more intermediate elements. Thus, in this embodiment opto-electronic light source 52 and opto-electronic light receiver 56 are coupled to castellations 46 via circuit traces 60.

In operation, integrated circuit device 66, in response to the above-referenced external electronic system, drives opto-electronic light source 52 by providing electrical signals on a pair of traces 64. Opto-electronic light source 52 receives these electrical signals via a corresponding pair of castellations 46 and, in response, emits an optical signal along optical signal transmit axis 54. Similarly, opto-electronic light receiver 56 produces electrical signals in response to receiving an optical signal along optical signal receive axis 58. These electrical signals are conveyed to another pair of traces 64 and, in turn, to integrated circuit device 66, via another corresponding pair of castellations 46.

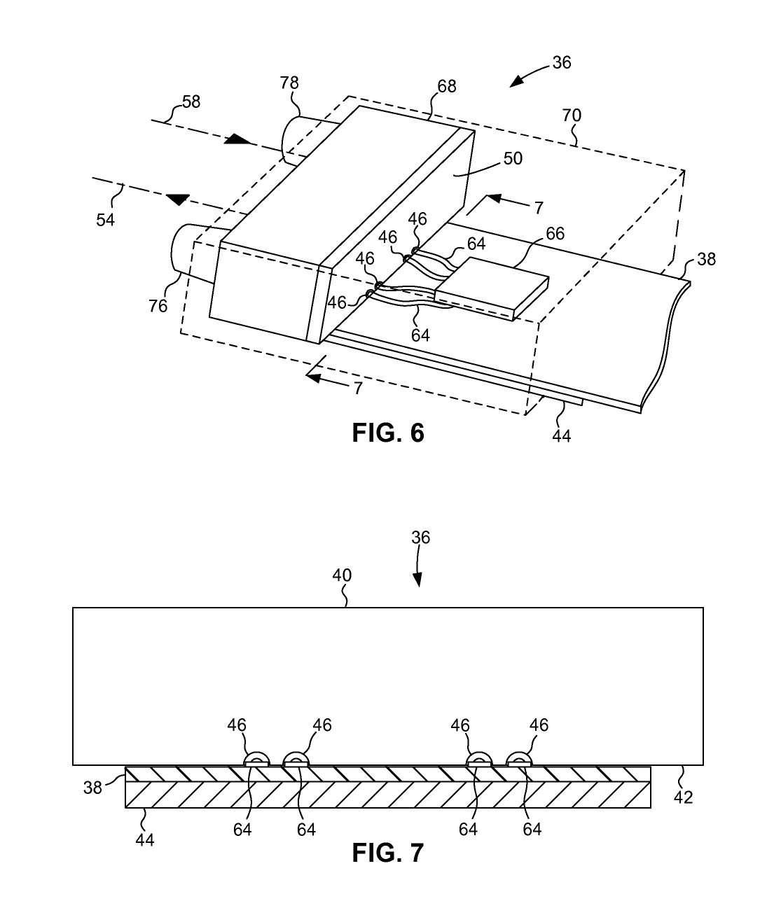

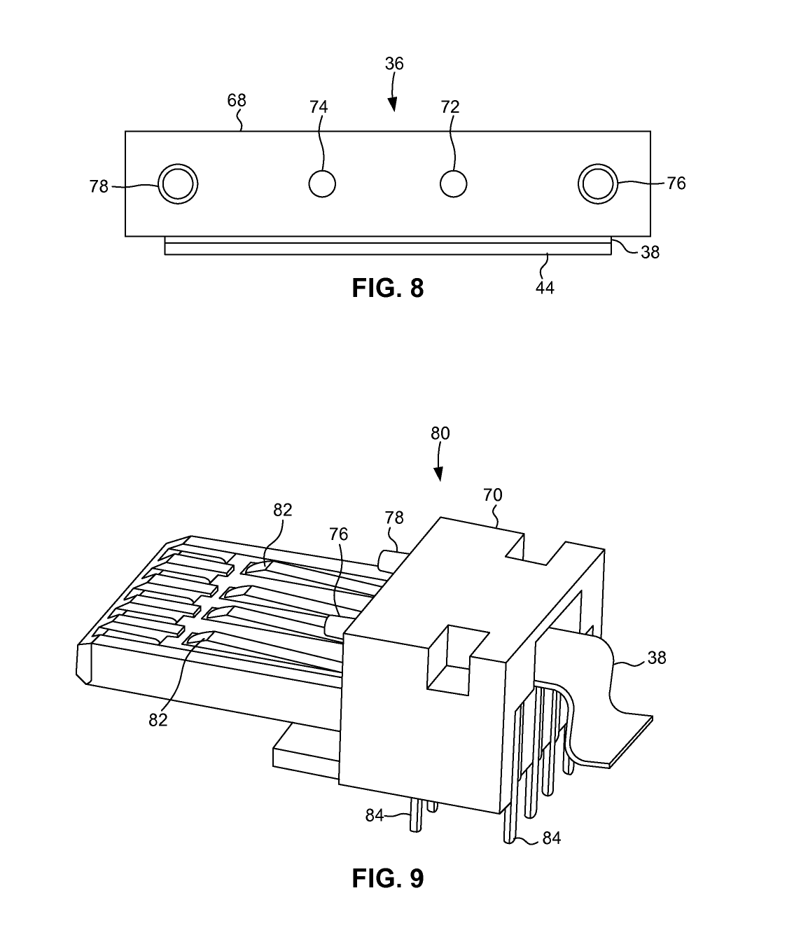

As illustrated in FIGS. 6-9, opto-electronic transceiver module 36 includes a module body, which can comprise, for example, a module body portion 68 and a module body housing 70. Module body portion 68 is attached to front surface 48 of circuit board 40. Although module body portion 68 is shown as having a somewhat box-like shape, it can have any suitable shape, including additional features to facilitate attaching it to other elements of an assembly. Although module body portion 68 appears solid in FIG. 6 for purposes of clarity of illustration, it may include interior voids or cavities as well as additional optical elements that support the optical signal paths described herein. Note that opto-electronic light source 52 and opto-electronic light receiver 56 operate upon optical signal paths that pass through module body portion 68, as indicated by optical signal transmit and receive axes 54 and 58. Module body portion 68 can include lenses 72 and 74 (FIG. 8) that are aligned with optical signal transmit and receive axes 54 and 58, respectively. Module body portion 68 can include two alignment posts 76 and 78. As illustrated in FIG. 9, module body housing 70 can be of a type similar to that included in a Universal Serial Bus (USB) receptacle, and alignment posts 76 and 78 can protrude through corresponding openings (not shown) in module body housing 70. Although not shown for purposes of clarity, the entire assembly 80 shown in FIG. 9 can be enclosed within a USB-like receptacle housing and mounted to a printed circuit board such as a computer motherboard. Note that assembly 80 includes not only opto-electronic transceiver module 36 but also electrical contact fingers 82 and electrical contact pins 84 for communicating USB electrical signals. Electrical contact pins 84 can be soldered to the above-referenced computer motherboard or other circuit board. Similar assemblies having both an opto-electronic transceiver module and electrical USB connections are described in co-pending U.S. patent application Ser. No. 12/628,163, filed Nov. 30, 2009, entitled “UNIVERSAL SERIAL BUS (USB) CONNECTOR HAVING AN OPTICAL-TO-ELECTRICAL/ELECTRICAL-TO-OPTICAL CONVERSION MODULE (OE MODULE) AND A HIGH-SPEED ELECTRICAL CONNECTION INTEGRATED THEREIN.”

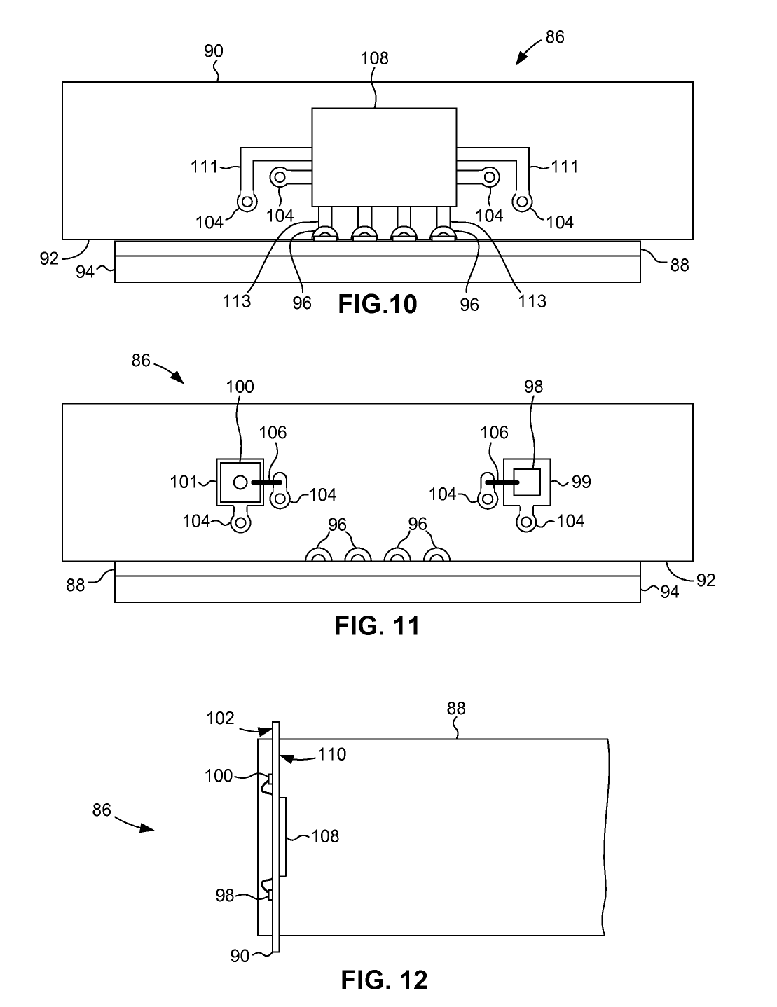

As illustrated in FIGS. 10-12, in another exemplary embodiment of the invention an opto-electronic transceiver module 86 includes a flexible circuit substrate or flex circuit 88 and a circuit board 90 attached perpendicularly to flex circuit 88. A module body like that described above is also included in this embodiment but is not shown in FIGS. 10-12 for purposes of clarity. Circuit board 90 is attached to the upper surface of flex circuit 88 along an edge 92 of circuit board 90. A generally planar stiffener 94 is attached to the lower surface of flex circuit 88 as in the embodiment described above with regard to FIGS. 3-9. Edge 92 includes castellations 96 as in the above-described embodiment. Castellations 96 can be soldered to circuit traces (not shown for purposes of clarity) on flex circuit 88. An opto-electronic light source 98 and an opto-electronic light receiver 100 are mounted on pads 99 and 101, respectively, on the front surface 102 of circuit board 90 and function in the same manner as opto-electronic light source 52 and opto-electronic light receiver 56 in the above-described embodiment. Wirebonds 106 and vias 104 electrically couple opto-electronic light source 98 and opto-electronic light receiver 100 to an integrated circuit device 108 mounted on the rear surface 110 of circuit board 90. Additional circuit traces 111 on rear surface 110 of circuit board 90 are included in this circuit path between vias 104 and integrated circuit device 108. Castellations 96 electrically couple integrated circuit device 108 via other circuit traces 113 on rear surface 110 to additional circuit traces (not shown for purposes of clarity) on flex circuit 88, which in turn can be coupled to an external electronic system, as in the embodiment described above with regard to FIGS. 3-9. Thus, in this embodiment opto-electronic light source 98 and opto-electronic light receiver 100 are coupled to castellations 96 via integrated circuit device 108.

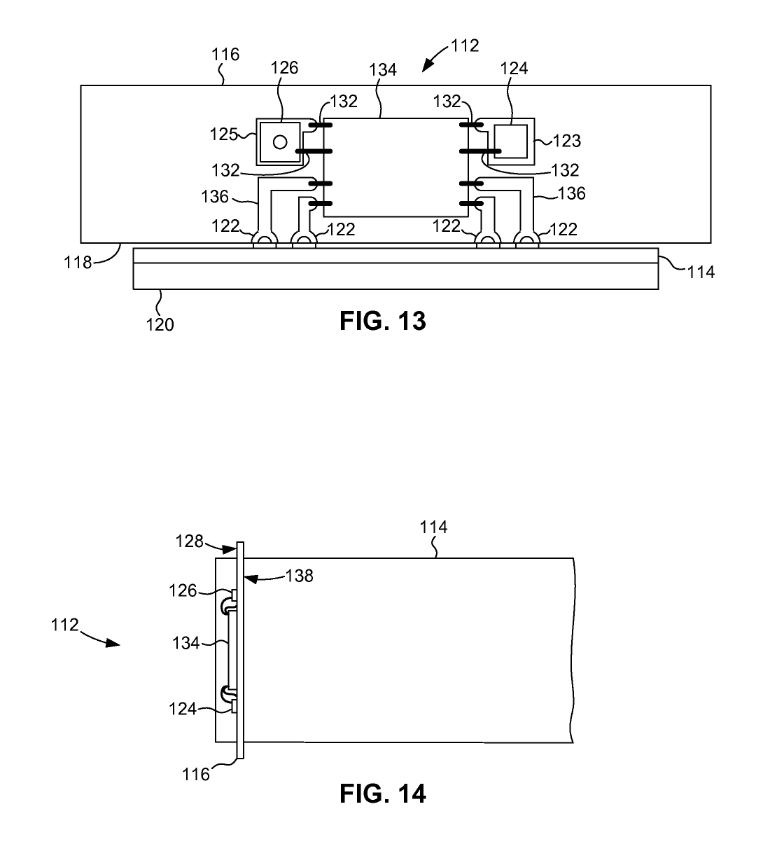

As illustrated in FIGS. 13-14, in still another exemplary embodiment of the invention an opto-electronic transceiver module 112 includes a flexible circuit substrate or flex circuit 114 and a circuit board 116 attached perpendicularly to flex circuit 114. A module body like that described above is also included in this embodiment but is not shown in FIGS. 13-14 for purposes of clarity. Circuit board 116 is attached to the upper surface of flex circuit 114 along an edge 118 of circuit board 116. A generally planar stiffener 120 is attached to the lower surface of flex circuit 114 as in the embodiment described above with regard to FIGS. 3-9. Edge 118 also includes castellations 122 as in the above-described embodiment. Castellations 122 can be soldered to circuit traces (not shown for purposes of clarity) on flex circuit 114. An opto-electronic light source 124 and an opto-electronic light receiver 126 are mounted on pads 123 and 125, respectively, on the front surface 128 of circuit board 116 and function in the same manner as opto-electronic light source 52 and opto-electronic light receiver 56 in the embodiment described above with regard to FIGS. 3-9. Wirebonds 132 electrically directly couple opto-electronic light source 124 and opto-electronic light receiver 126 to the integrated circuit device 134 mounted on front surface 128. Circuit traces 136 and additional wirebonds 132 on front surface 128 electrically couple integrated circuit device 134 to castellations 122. Castellations 122 electrically couple integrated circuit device 134 to circuit traces (not shown for purposes of clarity) on flex circuit 88, which in turn can be coupled to an external electronic system, as in the embodiment described above with regard to FIGS. 3-9. Thus, in this embodiment opto-electronic light source 124 and opto-electronic light receiver 126 are coupled to castellations 122 via integrated circuit device 134.

In the manner described above with regard to exemplary embodiments of the invention, castellations on a circuit board edge provide a 90-degree electrical turn in an opto-electronic transceiver module, thereby avoiding a complex or difficult-to-align optical turn. The above-described opto-electronic transceiver module can also promote manufacturing economy. The tight electrical turn can provide advantageously short conductive paths between the opto-electronic devices and the associated integrated circuit device.

One or more illustrative embodiments of the invention have been described above. However, it is to be understood that the invention is defined by the appended claims and is not limited to the specific embodiments described. For example, although a bidirectional embodiment having both an opto-electronic light source and an opto-electronic light receiver is described, other embodiments of the invention can include only one such opto-electronic communication device and not the other.

What is claimed is:

1. An opto-electronic communication module, comprising:
a module body having an optical signal transmit port and an optical signal receive port;
a circuit board connected to a portion of the module body, the circuit board having an edge with a plurality of conductive castellations extending between a first surface of the circuit board and a second surface of the circuit board;
a first opto-electronic communication device mounted on the first surface of the circuit board, the first opto-electronic communication device having an optical signal transmit axis normal to the circuit board and aligned with the optical signal communication port of the module body, the first opto-electronic communication device electrically coupled to at least a first one of the plurality of conductive castellations.

2. The opto-electronic communication module claimed in claim 1, wherein the first opto-electronic communication device comprises an opto-electronic light source mounted on the first surface of the circuit board, the opto-electronic light source having an optical signal transmit axis normal to the circuit board and aligned with the optical signal transmit port of the module body, the opto-electronic light source electrically coupled to at least a first one of the plurality of conductive castellations.

3. The opto-electronic communication module claimed in claim 1, wherein the first opto-electronic communication device comprises an opto-electronic light receiver mounted on the first surface of the circuit board, the opto-electronic light receiver having an optical signal receive axis normal to the first surface of the circuit board and aligned with the optical signal receive port of the module body, the opto-electronic light receiver electrically coupled to at least a second one of the plurality of conductive castellations.

4. The opto-electronic communication module claimed in claim 1, further comprising a second opto-electronic communication device, wherein:
the first opto-electronic communication device comprises an opto-electronic light source mounted on the first surface of the circuit board, the opto-electronic light source having an optical signal transmit axis normal to the circuit board and aligned with the optical signal transmit port of the module body, the opto-electronic light source electrically coupled to at least a first one of the plurality of conductive castellations; and
the second opto-electronic communication device comprises an opto-electronic light receiver mounted on the first surface of the circuit board, the opto-electronic light receiver having an optical signal receive axis normal to the first surface of the circuit board and aligned with the optical signal receive port of the module body, the opto-electronic light receiver electrically coupled to at least a second one of the plurality of conductive castellations.

5. The opto-electronic communication module claimed in claim 1, further comprising a circuit substrate having a plurality of conductive paths carrying electronic signals, the edge of the circuit board attached to a surface of the circuit substrate, with the circuit board substantially perpendicular to a portion of the circuit substrate, the plurality of conductive castellations electrically coupled to corresponding ones of the plurality of conductive paths of the circuit substrate.

6. The opto-electronic communication module claimed in claim 5, wherein the circuit substrate comprises a flexible circuit substrate.

7. The opto-electronic communication module claimed in claim 5, further comprising an integrated circuit device mounted on the surface of the circuit substrate and electrically coupled to the plurality of conductive castellations.

8. The opto-electronic communication module claimed in claim 1, further comprising an integrated circuit device mounted on the second surface of the circuit board and electrically coupled to the plurality of conductive castellations.

9. The opto-electronic communication module claimed in claim 1, further comprising an integrated circuit device mounted on the first surface of the circuit board and electrically coupled to the plurality of conductive castellations.

10. A method of operation of an opto-electronic communication module, the opto-electronic communication module comprising a module body having an optical signal communication port, a circuit board connected to a portion of the module body, and an opto-electronic communication device, the circuit board having an edge with a plurality of conductive castellations extending between a first surface of the circuit board and a second surface of the circuit board, the opto-electronic communication device mounted on the first surface of the circuit board and having an optical signal communication axis normal to the circuit board and aligned with the optical signal communication port of the module body, the opto-electronic communication device electrically coupled to at least a first one of the plurality of conductive castellations, the method comprising:
the opto-electronic communication device communicating an optical signal; and
the opto-electronic communication device communicating an electrical signal corresponding to the optical signal via one of the plurality of conductive castellations.

11. The method claimed in claim 10, wherein the opto-electronic communication device comprises an opto-electronic light source, the method comprising:
the opto-electronic light source receiving an electrical signal via a first one of the plurality of conductive castellations; and
the opto-electronic light source emitting an optical signal in response to the electrical signal through a transmit port of the module body along an optical signal transmit axis normal to the first surface of the circuit board.

12. The method claimed in claim 10, wherein the opto-electronic communication device comprises an opto-electronic light receiver, the method comprising:
the opto-electronic light receiver producing an electrical signal in response to receiving an optical signal through an optical signal receive port of the module body along an optical signal receive axis normal to the first surface of the circuit board; and
the opto-electronic light receiver providing the electrical signal via a second one of the plurality of conductive castellations.

13. The method claimed in claim 10, wherein the opto-electronic communication module further comprises a circuit substrate having a plurality of conductive paths carrying electronic signals, and wherein:
the opto-electronic communication device communicating an electrical signal corresponding to the optical signal via one of the plurality of conductive castellations comprises the opto-electronic communication device communicating the electrical signal with one of the plurality of conductive paths of the circuit substrate via one of the plurality of conductive castellations.

14. The method claimed in claim 10, wherein the opto-electronic communication module further comprises an integrated circuit device mounted on the surface of the circuit substrate and electrically coupled to the plurality of conductive castellations, and wherein:
the opto-electronic communication device communicating an electrical signal corresponding to the optical signal via one of the plurality of conductive castellations comprises one of the plurality of conductive castellations communicating the electrical signal between the opto-electronic light source and the integrated circuit device.

15. The method claimed in claim 10, wherein the opto-electronic communication module further comprises an integrated circuit device mounted on the circuit board and electrically coupled to the plurality of conductive castellations, and wherein:
the opto-electronic communication device communicating an electrical signal corresponding to the optical signal via one of the plurality of conductive castellations comprises one of the plurality of conductive castellations communicating the electrical signal between the integrated circuit device and one of the plurality of conductive paths of the circuit substrate.
